(19) United States
(12) Patent Application Publication
(10) Pub. No.: US 2016/0303689 A1
(43) Pub. Date: Oct. 20, 2016

(54) SUPERALLOY COMPOSITE PREFORMS AND APPLICATIONS THEREOF

(71) Applicant: Kennametal Inc., Latrobe, PA (US)

(72) Inventors: Martin Gerardo PEREZ, Latrobe, PA (US); Daniel J. De Wet, Inverary (CA); Joel Dawson, North Huntingdon, PA (US); Bob Monds, Trenton (CA)

(21) Appl. No.: 14/686,423

(22) Filed: Apr. 14, 2015

(51) Int. Cl. B23K 35/02; C08K 3/02; C22C 19/05; B23P 6/04; B23K 35/36; B23K 35/30; B23P 6/00; C08K 3/08; B23K 1/00

(52) U.S. Cl. CPC B23K 35/0222; C08K 3/08; C08K 3/02; C22C 19/057; C22C 19/058; B23K 1/0018; B23K 35/3613; B23K 35/304; B23P 6/005; B23P 6/045; B23K 35/0233; C08K 2003/0862

(57) ABSTRACT

In one aspect, composite preforms for the repair of superalloy parts and/or apparatus are described herein. For example, a composite preform comprises a nickel-based superalloy powder component, a nickel-based braze alloy powder component and a melting point depressant component disposed in a fibrous polymeric matrix. The fibrous polymeric matrix can form a flexible cloth in which the nickel-based superalloy powder component, nickel-based braze alloy powder component and melting point depressant component are dispersed.

### FIELD

The present invention relates to composite preforms and, in particular, to composite preforms for repairing superalloy components.

### BACKGROUND

Components of gas turbines, including blades and vanes, are subjected to harsh operating conditions leading to component damage by one or more mechanisms. Gas turbine components, for example, can suffer damage from thermal fatigue cracks, creep, oxidative surface degradation, hot corrosion and damage by foreign objects. If left unaddressed, such damage will necessarily compromise gas turbine efficiency and potentially lead to further turbine damage.

In view of such harsh operating conditions, turbine components are often fabricated of nickel-based or cobalt-based superalloy exhibiting high strength and high temperature resistance. Employment of superalloy compositions in conjunction with complex design and shape requirements renders gas turbine fabrication costly. A single stage of vanes for an aircraft turbine incurs a cost in the tens of thousands of dollars. Moreover, for industrial gas turbines, the cost can exceed one million dollars. Given such large capital investment, various methods have been developed to repair turbine components, thereby prolonging turbine life. Solid state diffusion bonding, conventional brazing, transient liquid phase bonding (TLP) and wide gap repair processes have been employed in turbine component repair. However, each of these techniques is subject to one or more disadvantages. Solid state diffusion bonding, for example, requires expensive jigs for alignment, application of high pressure and tight tolerances for mating surfaces. Such requirements increase cost and restrict turbine locations suitable for repair by this method. Conventional brazing results in a weld of significantly different composition than the superalloy component and is prone to formation of brittle eutectic phases. In contrast, TLP provides a weld of composition and microstructure substantially indistinguishable from that of the superalloy component. However, TLP is limited to structural damage or defects of 50 μm or less. As its name implies, wide gap repair processes overcome the clearance limitations of TLP and address defects in excess of 250 μm. Nevertheless, increases in scale offered by wide gap repair are countered by the employment of filler alloy compositions incorporating elements forming brittle intermetallic species with the superalloy component.

### SUMMARY

In one aspect, composite preforms for the repair of superalloy parts and/or apparatus are described herein. For example, a composite preform comprises a nickel-based superalloy powder component, a nickel-based braze alloy powder component and a melting point depressant component disposed in a fibrous polymeric matrix. The fibrous polymeric matrix can form a flexible cloth in which the nickel-based superalloy powder component, nickel-based braze alloy powder component and melting point depressant component are dispersed. In some embodiments, the melting point depressant component comprises boron in an amount of 0.2 to 2 weight percent of the composite preform. Further, the melting point depressant component can be provided as part of the nickel-based braze alloy powder. Alternatively, the melting point depressant component is independent of the nickel-based braze alloy powder.

In another aspect, methods of repairing nickel-based superalloy parts or apparatus are described herein. A method of repairing a nickel-based superalloy part comprises providing an assembly by application of at least one composite preform to a damaged area of the nickel-based superalloy part, the composite preform including a nickel-based superalloy powder component, a nickel-based braze alloy powder component and a melting point depressant component disposed in a fibrous polymeric matrix. The assembly is heated to form a filler alloy metallurgically bonded to the damaged area, the filler alloy formed from the nickel-based superalloy powder component and nickel-based braze alloy powder component. In some embodiments, the flexible cloth containing the alloy powders is cut to the desired dimensions for application to the damaged area.

These and other embodiments are further described in the following detailed description.

### BRIEF DESCRIPTION OF THE DRAWINGS

FIG. 1 is a cross-sectional scanning electron microscopy (SEM) image of a filler alloy metallurgically bonded to a nickel-based superalloy substrate according to one embodiment described herein.

FIG. 2 is a cross-sectional SEM image of a filler alloy metallurgically bonded to a nickel-based superalloy substrate according to one embodiment described herein.

FIG. 3 is a cross-sectional SEM image of a filler alloy metallurgically bonded to a nickel-based superalloy substrate according to one embodiment described herein.

FIG. 4 is a cross-sectional SEM image of a filler alloy metallurgically bonded to a nickel-based superalloy substrate according to one embodiment described herein.

FIG. 5 is a cross-sectional SEM image of a filler alloy metallurgically bonded to a nickel-based superalloy substrate according to one embodiment described herein.

### DETAILED DESCRIPTION

Embodiments described herein can be understood more readily by reference to the following detailed description and examples and their previous and following descriptions. Elements, apparatus and methods described herein, however, are not limited to the specific embodiments presented in the detailed description and examples. It should be recognized that these embodiments are merely illustrative of the principles of the present invention. Numerous modifications and adaptations will be readily apparent to those of skill in the art without departing from the spirit and scope of the invention.

### I. Composite Preforms

In one aspect, composite preforms for the repair of superalloy parts and/or apparatus are described herein. Such composite preforms comprise a nickel-based superalloy powder component, a nickel-based braze alloy powder component and a melting point depressant component disposed in a fibrous polymeric matrix. As detailed further herein, the nickel-based superalloy powder and nickel-based braze alloy powder can be dispersed throughout the fibrous polymeric matrix. Turning now to specific components, the nickel-based superalloy powder component can comprise one or more nickel-based superalloy powders. For example, suitable nickel-based superalloy powder can be compositionally similar or consistent with one or more nickel-based superalloys employed in the fabrication of gas turbine components, such as blades and vanes. In some embodiments, nickel-based superalloy powders have compositional parameters falling within nickel-based superalloy classes of conventionally cast alloys, directionally solidified alloys, first-generation single-crystal alloys, second generation single-crystal alloys, third generation single-crystal alloys, wrought superalloys and/or powder processed superalloys. In some embodiments, a nickel-based superalloy powder has composition of 0.05-0.2 wt. % carbon, 7-9 wt. % chromium, 8-11 wt. % cobalt, 0.1-1 wt. % molybdenum, 9-11 wt. % tungsten, 3-4 wt. % tantalum, 5-6 wt. % aluminum, 0.5-1.5 wt. % titanium, less than 0.02 wt. % boron, less than 0.02 wt. % zirconium, less than 2 wt. % hafnium and the balance nickel. In several specific embodiments, the nickel-based superalloy powder component can include an alloy powder selected from Table I.

TABLE I
Nickel-based superalloy powder composition (wt. %)

| Alloy | | | | | | | | | | | | |
|---|---|---|---|---|---|---|---|---|---|---|---|---|
| Powder | Ni | C | Cr | Co | Mo | W | Ta | Al | Ti | B | Zr | Hf |
| 1 | Bal. | 0.05-0.1 | 7-9 | 8-10 | 0.1-1 | 9-11 | 3-4 | 5-6 | 0.5-1 | 0.01-0.02 | 0.005-0.02 | 1-2 |
| 2 | Bal. | 0.1-0.2 | 8-9 | 9-11 | 0.5-1 | 9-11 | 3-4 | 5-6 | 0.5-1.5 | 0.01-0.02 | 0.01-0.1 | 1-2 |
| 3 | Bal. | 0.1-0.2 | 12-15 | 8-11 | 3-5 | 3-5 | — | 2-4 | 4-6 | 0.01-0.03 | 0.02-0.04 | — |
| 4 | Bal. | 0.1-0.2 | 14-17 | 9-11 | 8-10 | — | — | 3-5 | 3-5 | 0.005-0.02 | — | — |
| 5 | Bal. | 0.05-0.15 | 11-14 | 8-10 | 1-3 | 3-5 | 3-5 | 3-5 | 3-5 | 0.01-0.03 | 0.05-0.07 | 0.5-2 |
| 6 | Bal. | — | 9-11 | 4-6 | — | 3-5 | 11-13 | 4-6 | 1-3 | — | — | — |
| 7 | Bal. | 0.05-0.08 | 12-14 | 7-9 | 3-5 | 3-5 | 3-5 | 3-5 | 2-4 | 0.01-0.02 | 0.04-0.06 | — |
| | | | | | | | (Nb)* | | | | | |
| 8 | Bal. | 0.02-0.04 | 15-17 | 12-14 | 3-5 | 3-5 | 0.6-0.8 | 1-3 | 3-5 | 0.01-0.02 | — | — |
| | | | | | | | (Nb)* | | | | | |

*Nb replacing Ta

Suitable nickel-based superalloy powder of the composite preform, in some embodiments, is commercially available from General Electric approved suppliers. An additional commercially available nickel-based superalloy powder for use in a composite preform described herein is Mar M247.

Nickel-based superalloy powder of the composite preform can have any desired particle size. Particle size can be selected according various criteria including, but not limited to, dispersability in the fibrous polymeric matrix, packing characteristics and/or surface area for interaction and/or reaction with the nickel-based braze alloy component. In some embodiments, for example, nickel-based superalloy powder has an average particle size of 10 μm to 100 μm or 30 μm to 70 μm. Further, the nickel-based superalloy powder component is generally present in an amount of 45 to 95 weight percent of the composite preform. In some embodiments, the nickel-based superalloy powder component is present in the composite preform in an amount selected from Table II.

TABLE II
Nickel-based superalloy powder of composite preform (wt. %)
55-90
60-85
65-75
70-80

In addition to the nickel-based superalloy powder component, a composite preform described herein comprises a nickel-based braze alloy powder component. The nickel-based braze alloy powder component can comprise one or more nickel-based braze alloy powders. Any nickel-based braze alloy powder not inconsistent with the objectives of the present invention can be employed. For example, suitable nickel-based braze alloy powder can have a melting point lower than the nickel-based superalloy powder of the composite preform. In some embodiments, nickel-based braze alloy powder has a melting point at least 100° C. less than the nickel-based superalloy powder. In a specific embodiment, the nickel-based braze alloy powder component can include an alloy powder having the composition set forth in Table III.

TABLE III
Nickel-based braze alloy powder composition (wt %)

| Alloy | | | | | | | | | | | | |
|---|---|---|---|---|---|---|---|---|---|---|---|---|
| Powder | Ni | C | Cr | Co | Mo | Fe | Ta | Al | Ti | B | Zr | Mn |
| 1 | Bal. | 0.01-0.03 | 14-17 | 9-12 | 0.005-0.02 | 0.05-0.2 | 2-5 | 2-5 | 0.005-0.02 | 1.5-3 | 0.05-0.2 | 0.005-0.02 |

Nickel-based braze alloy powder having composition falling within the parameters of Table III is commercially available under the Amdry D15 trade designation. Additional suitable nickel-based braze alloy powders can be selected from the Amdry line and other commercially available powders.

Nickel-based braze alloy powder of the composite preform can have any desired particle size. Particle size can be selected according various criteria including, but not limited to, dispersability in the fibrous polymeric matrix, packing characteristics and/or surface area for interaction and/or reaction with the nickel-based superalloy powder component. In some embodiments, for example, nickel-based braze alloy powder has an average particle size of 10 μm to 150 μm or 40 μm to 125 μm. Further, the nickel-based superalloy powder component is generally present in an amount of 10 to 45 weight percent of the composite preform. In some embodiments, the nickel-based superalloy powder component is present in the composite preform in an amount selected from Table IV.

TABLE IV
Nickel-based superalloy powder of composite preform (wt. %)
15-40
25-35
20-30

As described herein, the composite preform includes a melting point depressant component in addition to the nickel-based superalloy powder and nickel-based braze alloy powder components. Any melting point depressant not inconsistent with the objectives of the present invention can be employed. For example, suitable melting point depressant can include boron, magnesium, hafnium, zirconium, MgNi₂, silicon or combinations thereof. Generally, the melting point depressant component is present in an amount of 0.2 to 20 weight percent of the composite preform. In some embodiments, the melting point depressant component comprises boron in an amount of 0.2 to 2 weight percent of the composite preform. In some specific embodiments, boron is present in the composite preform in an amount selected from Table V.

```
TABLE V
Boron Content of Composite Preform (wt. %)
1.3-2.0
1.1-1.2
  0.9-0.95
0.7-0.8
0.5-0.6
0.3-0.4
  0.2-0.25
  0.2-0.95
  0.3-0.92
0.3-1.5
```

Boron, in some embodiments, is the sole species of the melting point depressant component. Alternatively, boron can be combined with one or more additional melting point depressant species. For example, boron can be combined with hafnium or MgNi₂ to provide the melting point depressant component. In some embodiments, boron is combined with hafnium according to Table VI.

TABLE VI
Boron-Hafnium Content of Composite Preform (wt. %)

| Boron | Hafnium |
|---|---|
| 1.1-1.2 | 15-17 |
| 0.9-0.95 | 15-17 |
| 0.7-0.8 | 15-17 |
| 0.5-0.6 | 15-17 |
| 0.3-0.4 | 15-17 |
| 0.2-0.25 | 15-17 |
| 1.1-1.2 | 0.5-2 |
| 0.9-0.95 | 0.5-2 |
| 0.7-0.8 | 0.5-2 |
| 0.5-0.6 | 0.5-2 |
| 0.3-0.4 | 0.5-2 |
| 0.2-0.25 | 0.5-2 |

The melting point depressant component, in some embodiments, is part of the nickel-based braze alloy powder component and/or nickel-based superalloy powder component. Nickel-based braze alloy and/or nickel based superalloy can incorporate the melting point depressant as part of the alloy composition. For example, nickel-based braze alloy powder can be selected to contain boron and/or hafnium to serve as the melting point depressant component. In such embodiments, the nickel-based braze alloy powder component and nickel-based superalloy powder component can be added to the composite preform at a ratio to provide the desired amount of melting point depressant. Generally, the ratio of nickel-based superalloy powder component/nickel-based braze alloy powder component in the composite preform ranges from 1 to 10. In some specific embodiments, ratio of nickel-based superalloy powder component/nickel-based braze alloy powder component in the composite preform is selected from Table VII.

TABLE VII
Ni-Based Superalloy/Ni-Based Braze Alloy Ratio
8-9
5-6
2.5-3.5
1-2
1.75-2

Alternatively, the melting point depressant component can be provided to the composite preform independent of the nickel-based superalloy powder component and nickel-based braze alloy powder component. For example, melting point depressant powder can be added to the nickel-based powders of the composite preform.

The nickel-based superalloy powder component, nickel-based braze alloy component and melting point depressant component are disposed in a fibrous polymeric matrix. As detailed further in the examples below, the fibrous polymeric matrix can form a flexible cloth in which the nickel-based superalloy powder component, nickel-based braze alloy powder component and melting point depressant component are dispersed. The flexible polymeric cloth can have any thickness not inconsistent with the objectives of the present invention. For example, the flexible polymeric cloth can generally have a thickness of 0.2-4 mm or 1-2 mm Any polymeric species operable to adopt a fiber or filament morphology can be used in matrix construction. Suitable polymeric species can include fluoropoymers, polyamides, polyesters, polyolefins or mixtures thereof. In some embodiments, for example, the fibrous polymeric matrix is formed of fibrillated polytetrafluoroethylene (PTFE). In such embodiments, the PTFE fibers or fibrils can provide an interconnecting network matrix in which the nickel-based superalloy powder component and nickel-based braze alloy powder component are dispersed and trapped. Moreover, fibrillated PTFE can be combined with other polymeric fibers, such as polyamides and polyesters to modify or tailor properties of the fibrous matrix. The fibrous polymeric matrix generally accounts for less than 1.5 weight percent of the composite preform. In some embodiments, for example, the fibrous polymeric matrix accounts for 1.0-1.5 weight percent or 0.5-1.0 weight percent of the composite preform.

The composite preform can be fabricated by various techniques to disperse the nickel-based superalloy powder component, nickel-based braze alloy powder component and melting point depressant component in the fibrous polymeric matrix. In some embodiments, the composite preform is fabricated by combining polymeric powder, nickel-based superalloy powder and nickel-based braze alloy powder and mechanically working the mixture to fibrillate the polymeric powder and trap the nickel-based alloy powders in the resulting fibrous polymeric matrix. In such embodiments, the melting point depressant component is a constituent of the nickel-based braze alloy powder and/or nickel-based superalloy powder. In a specific embodiment, for example, nickel-based superalloy powder and nickel-based braze alloy powder are mixed with 3-15 vol. % of PTFE powder and mechanically worked to fibrillate the PTFE and trap the nickel-based alloy powders in a fibrous PTFE matrix. Nickel-based superalloy powder and nickel-based braze alloy powder can be selected from Tables I and III above, wherein the melting point depressant component, such as boron, is provided as a constituent of the nickel-based braze alloy. Mechanical working of the powder mixture can include ball milling, rolling, stretching, elongating, extruding, spreading or combinations thereof. In some embodiments, the resulting PTFE-flexible composite preform cloth is subjected to cold isostatic pressing. A composite preform described herein can be produced in accordance with the disclosure of one or more of U.S. Pat. Nos. 3,743,556, 3,864,124, 3,916,506, 4,194,040 and 5,352,526, each of which is incorporated herein by reference in its entirety.

### II. Methods of Nickel-Based Superalloy Repair

In another aspect, methods of repairing nickel-based superalloy parts or apparatus are described herein. A method of repairing a nickel-based superalloy part comprises providing an assembly by application of at least one composite preform to a damaged area of the nickel-based superalloy part, the composite preform including a nickel-based superalloy powder component, a nickel-based braze alloy powder component and a melting point depressant component disposed in a fibrous polymeric matrix. The assembly is heated to form a filler alloy metallurgically bonded to the damaged area, the filler alloy formed from the nickel-based superalloy powder component and nickel-based braze alloy powder component. In some embodiments, the flexible cloth containing the alloy powders is cut to the desired dimensions for application to the damaged area.

Composite preforms having any construction and compositional properties described in Section I herein can be applied to a damaged area of a nickel-based superalloy part to provide an assembly. A damaged area of a nickel-based superalloy part can include cracks, oxidative surface degradation and/or other chemical degradation, hot corrosion, pitting and damage by foreign objects. Therefore, filler alloy formed one or more composite preforms is additive to the damaged area and is not viewed as a protective cladding. A composite preform can be applied to the damaged area by any means not inconsistent with the objectives of the present invention. For example, the composite preform can be applied by use of adhesive or tape. The flexible nature provided by the cloth-like fibrous polymeric matrix enables composite preforms described herein to conform to complex shapes and geometries of various nickel-based superalloy parts. As described herein, composite preforms can be employed in the repair of gas turbine parts, including turbine blades and vanes. The flexible cloth-like nature of the fibrous polymeric matrix facilitates application of the composite preform to various regions of a turbine blade including the pressure side wall, suction side wall, blade tip, leading and trailing edges as well as the blade root and platform.

In some embodiments, a single composite preform is applied to the damaged area of the nickel-based superalloy part. Alternatively, multiple composite preforms can be applied to the damaged area of the nickel-based superalloy part. For example, composite preforms can be applied in a layered format over the damaged area. Layering the composite preforms can enable production of filler alloy of any desired thickness. In some embodiments, composite preforms are layered to provide a filler alloy having thickness of at least 5 cm or at least 10 cm. The damaged area of the nickel-based superalloy part can be subjected to one or more preparation techniques prior to application of composite preforms described herein. The damaged area, for example, can be cleaned by chemical and/or mechanical means prior to composite preform application, such as by fluoride ion cleaning.

Subsequent to application of one or more composite preforms to the damaged area of the nickel-based superalloy part, the resulting assembly is heated to form a filler alloy metallurgically bonded to the damaged area. Heating the assembly decomposes the polymeric fibrous matrix, and the filler alloy is formed from the nickel-based superalloy powder component and the nickel-based braze alloy component of the composite preform(s). The assembly is generally heated to a temperature in excess of the melting point of the nickel-based braze alloy powder component and below the melting point of the nickel-based superalloy powder component. Therefore, the nickel-based braze alloy powder is melted forming the filler alloy with the nickel-based superalloy powder, wherein the filler alloy is metallurgically bonded to the nickel-based superalloy part. Molten flow characteristics of the nickel-based braze alloy permits formation of a void-free interface between the filler alloy and the nickel-based superalloy part. Heating temperature and heating time period are dependent on the specific compositional parameters of the nickel-based superalloy part and composite preform. In some embodiments, for example, the assembly is heated to a temperature of 1200-1250° C. for a time period of 1 to 4 hours.

In some embodiments, the filler alloy exhibits a uniform or substantially uniform microstructure. As provided in the figures herein, the filler alloy microstructure can differ from the microstructure of the nickel-based superalloy part. Moreover, the filler alloy microstructure can be free or substantially free of brittle metal boride precipitates, including various chromium borides [CrB, (Cr,W)B, Cr(B,C), Cr₅B₃] and/or nickel borides such as Ni₃B. Further, the filler alloy can be fully dense or substantially fully dense. In being substantially fully dense, the filler alloy can have less than 5 volume percent porosity.

Additionally, an interfacial transition region can be established between the filler alloy and the nickel-based superalloy part. The interfacial transition region can exhibit a microstructure differing from the filler alloy and the nickel-based superalloy part. The interfacial transition region, in some embodiments, is free or substantially free of brittle metal boride precipitates, including the chromium boride and nickel boride species described above. An interfacial transition region, in some embodiments, has a thickness of 20-150 μm.

Subsequent to metallurgical bonding of the filler alloy over the damaged area, the repaired nickel-based superalloy part may be subjected to additional treatments including solutionizing and heat aging. In some embodiments, a protective refractory coating can be applied to the repaired nickel-based superalloy part. For example, a protective refractory coating can comprise one or more metallic elements selected from the group consisting of aluminum and metallic elements of Groups IVB, VB and VIB of the Periodic Table and one or more non-metallic elements selected from Groups IIIA, IVA, VA and VIA of the Periodic Table. A protective refractory layer can comprise a carbide, nitride, carbonitride, oxycarbonitride, oxide or boride of one or more metallic elements selected from the group consisting of aluminum and metallic elements of Groups WB, VB and VIB of the Periodic Table. For example, one or more protective layers can be selected from the group consisting of titanium nitride, titanium carbonitride, titanium oxycarbonitride, titanium carbide, zirconium nitride, zirconium carbonitride, hafnium nitride, hafnium carbonitride and alumina and mixtures thereof. These and other embodiments are further illustrated in the following non-limiting examples.

### Example 1

### Composite Article

A composite article was formed by application of a composite preform described herein to a nickel-based superalloy substrate as follows. 400 g of nickel-based superalloy powder having compositional parameters of Alloy Powder 1 of Table 1 (Rene' 108) and 134 g nickel-based braze alloy powder of Table III (Amdry D15) were mixed with 5-15 vol. % of powder PTFE. The powder mixture was mechanically worked to fibrillate the PTFE and trap the nickel-based superalloy powder and nickel-based braze alloy powder and then rolled, thus forming the composite preform as a cloth-like flexible sheet of thickness 1-2 mm. The composite preform contained 0.57 wt. % boron as the melting point depressant component. As described herein, the boron melting point depressant component was provided as part of the Amdry D15.

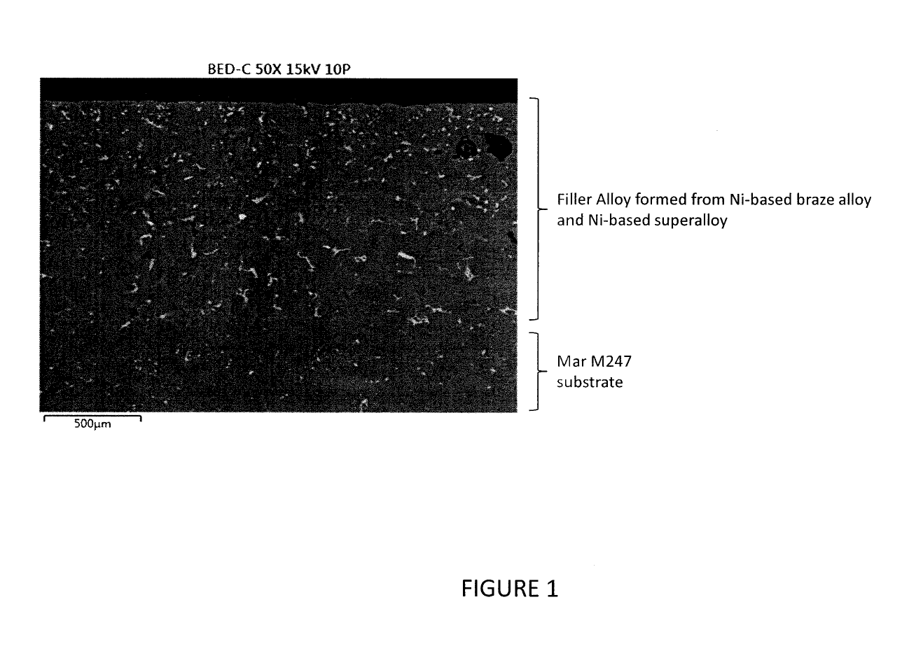

The composite preform was adhered to a Mar M247 substrate to provide an assembly. The assembly was heated to a temperature of 1220-1250° C. under vacuum for a time period of three hours. A filler alloy was formed from the nickel-based braze alloy powder and nickel-based superalloy powder and metallurgically bonded to the Mar M247 substrate. As evidenced by the cross-sectional SEM image (50×) of FIG. 1, the filler alloy was substantially fully dense and the interface with the Mar M247 substrate was void-free.

### Example 2

### Composite Article

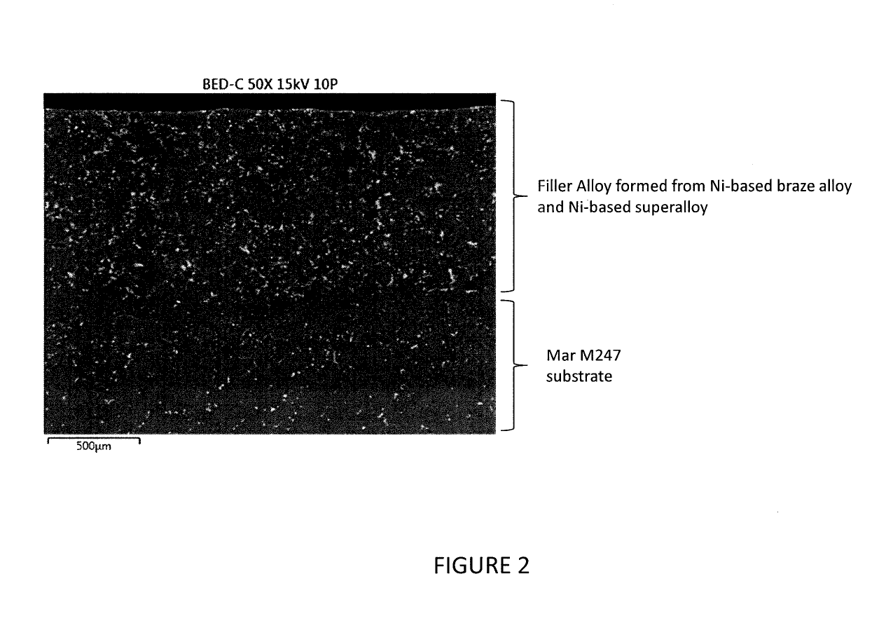

A composite article was produced in accordance with Example 1, wherein the Rene' 108 superalloy powder was replaced with Mar M247 powder. The resulting composite preform contained 0.56 wt. % boron as the melting point depressant component. FIG. 2 is a cross-sectional SEM (50×) illustrating metallurgical bonding of the filler alloy to the Mar M247 substrate. The filler alloy was substantially fully dense, and the interface with the Mar M247 substrate was void-free.

### Example 3

### Composite Article

A composite article was formed by application of a composite preform described herein to a nickel-based superalloy substrate as follows. 470 g of nickel-based superalloy powder Rene' 108 and 235 g nickel-based braze alloy powder Amdry D15 were mixed with 5-15 vol. % of powder PTFE. The powder mixture was mechanically worked to fibrillate the PTFE and trap the Rene' 108 powder and Amdry D15 powder and then rolled, thus forming the composite preform as a cloth-like flexible sheet of thickness 1-2 mm. The composite preform contained 0.75 wt. % boron as the melting point depressant component. As described herein, the boron melting point depressant component was provided as part of the Amdry D15.

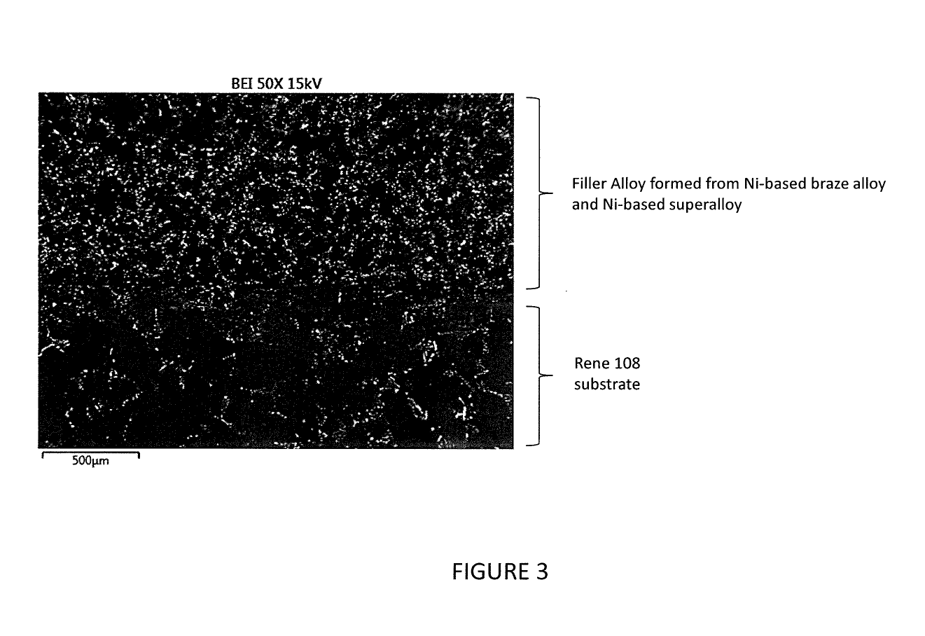

The composite preform was adhered to a Rene' 108 substrate to provide an assembly. The assembly was heated to a temperature of 1220−1250° C. under vacuum for a time period of 1 hour. A filler alloy was formed from the nickel-based braze alloy powder and nickel-based superalloy powder and metallurgically bonded to the Rene' 108 substrate. As evidenced by the cross-sectional SEM image (50×) of FIG. 3, the interface of the filler alloy and Rene' 108 substrate was void-free.

### Example 4

### Composite Article

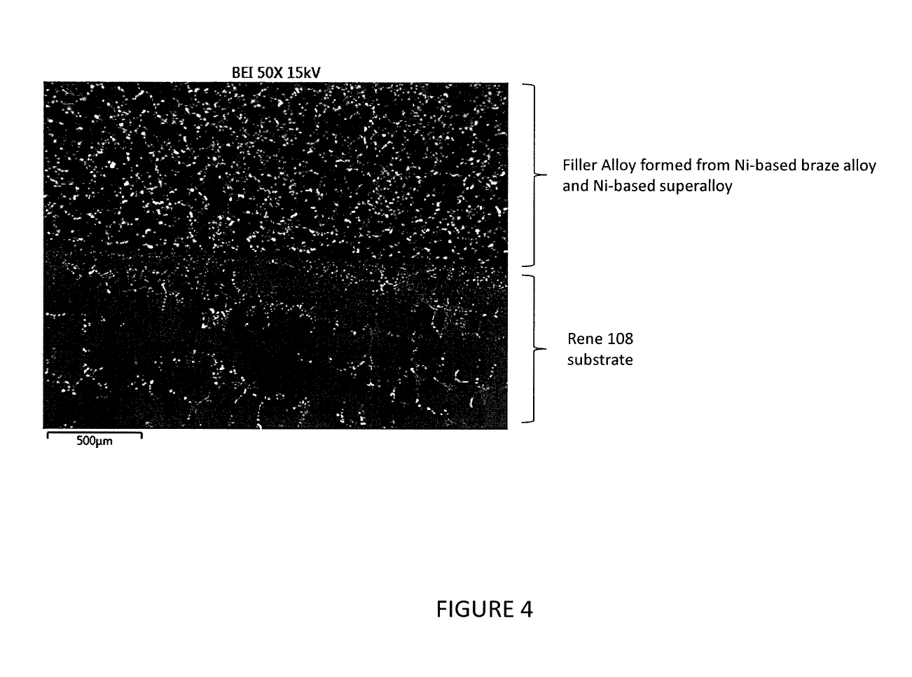

A composite article was formed in accordance with Example 3. However, 420 g of Rene' 108 and 280 g of Amdry D15 were used to fabricate the composite preform and provide 0.92 wt. % boron as the melting point depressant component. As provided in the SEM (50×) of FIG. 4, the resulting filler alloy was substantially fully dense, and the interface with the Rene' 108 substrate was void-free.

### Example 5

### Composite Article

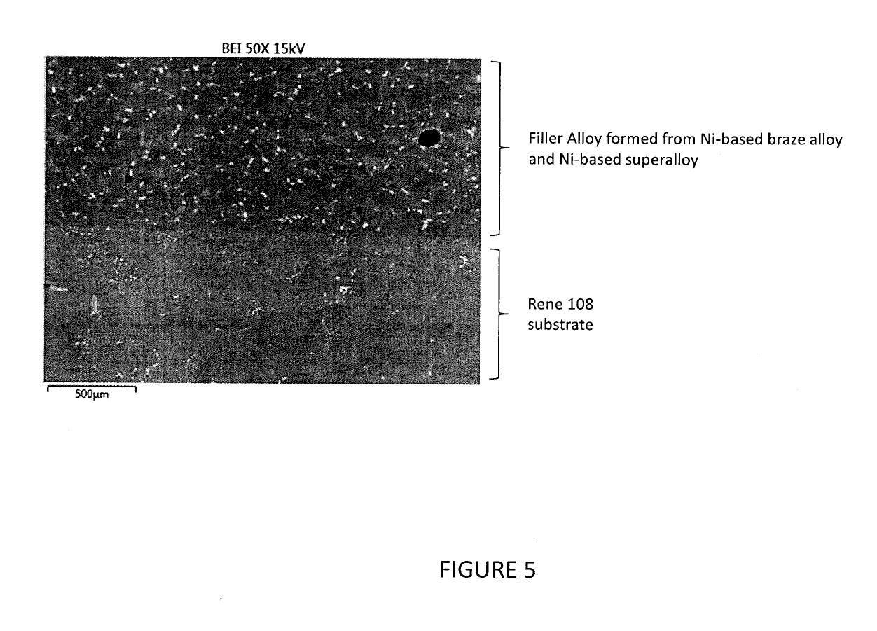

A composite article was formed in accordance with Example 3. However, 350 g of Rene' 108 and 350 g of Amdry D15 were used to fabricate the composite preform and provide 1.15 wt. % boron as the melting point depressant component. As provided in the SEM (50×) image FIG. 5, the resulting filler alloy was substantially fully dense, and the interface with the Rene' 108 substrate was void-free.

Various embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the invention.

1. A composite preform comprising:
a nickel-based superalloy powder component, a nickel-based braze alloy powder component and a melting point depressant component disposed in a fibrous polymeric matrix.

2. The composite preform of claim 1, wherein the fibrous polymeric matrix is cloth-like having a thickness of 0.2-4 mm.

3. The composite preform of claim 2, wherein the nickel-based superalloy powder component, nickel-based braze alloy powder component and melting point depressant component are dispersed throughout the fibrous polymeric matrix.

4. The composite preform of claim 2, wherein the fibrous polymeric matrix comprises fibrillated polytetrafluoroethylene.

5. The composite preform of claim 1, wherein the melting point depressant component is present in an amount of 0.2 to 20 weight percent of the composite preform.

6. The composite preform of claim 5, wherein the melting point depressant component comprises boron in an amount of 0.2 to 2 weight percent of the composite preform.

7. The composite preform of claim 5, wherein the melting point depressant component comprises boron in an amount of 0.2 to 0.95 weight percent of the composite preform.

8. The composite preform of claim 5, wherein the melting point depressant component comprises boron in an amount of 0.7 to 0.8 weight percent of the composite preform.

9. The composite preform of claim 6, wherein the melting point depressant component further comprises at least one of magnesium, hafnium, zirconium, MgNi₂ and silicon.

10. The composite preform of claim 6, wherein the boron is provided by the nickel-based braze alloy powder, the nickel-based superalloy powder or combinations thereof.

11. The composite preform of claim 1, wherein the nickel-based superalloy powder is of composition of 0.05-0.2 wt. % carbon, 7-9 wt. % chromium, 8-11 wt. % cobalt, 0.1-1 wt. % molybdenum, 9-11 wt. % tungsten, 3-4 wt. % tantalum, 5-6 wt. % aluminum, 0.5-1.5 wt. % titanium, less than 0.02 wt. % boron, less than 0.02 wt. % zirconium, less than 2 wt. % hafnium and the balance nickel.

12. The composite preform of claim 11, wherein the nickel-based braze alloy powder is of composition 0.01-0.03 wt. % carbon, 14-17 wt. % chromium, 9-12 wt. % cobalt, less than 0.02 wt. % molybdenum, 0.05-0.2 wt. % iron, 2-5 wt. % tantalum, 2-5 wt. % aluminum, less than 0.02 wt. % titanium, 1.5-2.5 wt. % boron, 0.05-0.2 wt. % zirconium, less than 0.02 wt. % manganese and the balance nickel.

13. The composite preform of claim 1, wherein a ratio of the nickel-based superalloy powder component to the nickel-based braze alloy powder component ranges from 2-3.

14. A method of repairing a nickel-based superalloy part comprising:
providing an assembly by application of at least one composite preform to a damaged area of the nickel-based superalloy part, the composite preform including a nickel-based superalloy powder component, a nickel-based braze alloy powder component and a melting point depressant component disposed in a fibrous polymeric matrix; and
heating the assembly to form a filler alloy metallurgically bonded to the damaged area, the filler alloy formed from the nickel-based superalloy powder component and nickel-based braze alloy powder component.

15. The method of claim 14, wherein the nickel-based braze alloy powder component has a melting point lower than the nickel-based superalloy powder component.

16. The method of claim 15, wherein the assembly is heated to a temperature greater than the melting point of the nickel-based braze alloy powder component and less than the melting point of the nickel-based superalloy powder component.

17. The method of claim 16, wherein the filler alloy is substantially fully dense.

18. The method of claim 16, wherein the filler alloy forms a void-free interface with the nickel-based superalloy part.

19. The method of claim 14, wherein an interfacial transition region is established between the filler alloy and the nickel-based superalloy part.

20. The method of claim 19, wherein the interfacial transition region is free of brittle metal boride precipitates.

21. The method of claim 14, wherein the fibrous polymeric matrix is cloth-like having a thickness of 0.2-4 mm.

22. The method of claim 14, wherein the melting point depressant component is present in an amount of 0.2 to 20 weight percent of the composite preform.

23. The method of claim 22, wherein the melting point depressant component comprises boron in an amount of 0.2 to 1.2 weight percent of the composite preform.

24. The method of claim 23, wherein the melting point depressant component further comprises at least one of magnesium, hafnium, zirconium, MgNi₂ and silicon.

25. The method of claim 23, wherein the boron is provided by the nickel-based braze alloy powder, the nickel-based superalloy powder or combinations thereof.

26. The method of claim 14, wherein the nickel-based superalloy powder is of composition of 0.05-0.2 wt. % carbon, 7-9 wt. % chromium, 8-11 wt. % cobalt, 0.1-1 wt. % molybdenum, 9-11 wt. % tungsten, 3-4 wt. % tantalum, 5-6 wt. % aluminum, 0.5-1.5 wt. % titanium, less than 0.02 wt. % boron, less than 0.02 wt. % zirconium, less than 2 wt % hafnium and the balance nickel.

27. The method of claim 26, wherein the nickel-based braze alloy powder is of composition 0.01-0.03 wt. % carbon, 14-17 wt. % chromium, 9-12 wt. % cobalt, less than 0.02 wt. % molybdenum, 0.05-0.2 wt. % iron, 2-5 wt. % tantalum, 2-5 wt. % aluminum, less than 0.02 wt. % titanium, 1.5-2.5 wt. % boron, 0.05-0.2 wt. % zirconium, less than 0.02 wt. % manganese and the balance nickel.

28. The method of claim 14, wherein the damaged nickel-based superalloy part is a component of a gas turbine.

29. The method of claim 28, wherein the component is a turbine blade or vane.
